(19) United States
(12) Patent Application Publication
(10) Pub. No.: US 2011/0281460 A1
(43) Pub. Date: Nov. 17, 2011

(54) Twisted Quick Connector

(76) Inventor: Allen D. Fischbein, Westwood, NJ (US)

(21) Appl. No.: 12/778,608

(22) Filed: May 12, 2010

(51) Int. Cl. H01R 13/73

(52) U.S. Cl. 439/545

(57) ABSTRACT

A twisted quick connector for connecting a spiraled armored electrical conduit or cable. (BX) to a junction box. It is applied onto the end of the spiraled armored conduit or the BX cable by twisting it clockwise by hand, thereby threading it on to the spirals. Engagement of the connector to the end of the conduit or the armored BX cable is secured, and providing grounding passage through it.

### BACKGROUND OF THE INVENTION

The present invention relates generally to the field of electrical conduits and fittings. More specifically, the present invention is directed to connectors used to join an armored conduit or cable referred to as a BX Cable to an electrical junction box. Most available connectors for BX cables secure the armored conduit or cable to the BX connector by means of set screws and then with, a locknut to the junction box. In existing connectors, at the end of the armored cable, the operator must insert anti-short plastic bushings. The bushings are required to prevent shorting the wires to ground due to the sharp edges of the end of the armored cable that can cut through the insulation on the outside of the wires. This technology for connecting armored conduit or cable to a junction box has been used for many years.

A primary object of the present invention is to create a simple, easy-to-use connecting device to join an armored cable to a junction box. Another object of the present invention is to eliminate the need for using set screws to join the armored cable to the BX connector and then to the junction box. Another object of this invention is to insure that using the present connector having the above gain in efficiency does not compromise the workmanship quality and utilizes a safe electrical installation process. Still another object of this invention is to isolate the wiring from short grounding due to the sharp edges of the armored conduit or the BX cable end, without the need for an isolating bushing. Yet another object of this invention is to secure the armored conduit or the BX cable in place utilizing a threaded inside part of the connector.

### SUMMARY OF THE INVENTION

A connector for connecting an armored electrical conduit comprising a spiral exterior to an opening in an electrical junction box, comprising a generally cylindrical body with a hollow tubular interior comprising a first end and a second end adapted to receive a plurality of electrical wires in the hollow tubular interior. The first end comprising a generally hexagonal exterior with a first set of spiral worm threads on its interior surface and an internal stop whereby the first set of threads are adapted to engage the spiral exterior of the armored electrical conduit whereby the connector is rotated over the spiral exterior of the armored cable until the stop contacts a leading edge of the armored electrical conduit. The second end comprising an external diameter adapted to be received in the opening in the electrical junction box and a second set of threads on an exterior surface of the second end adapted to be received in a locknut to secure the connector and the armored conduit to the electrical junction box.

### BRIEF DESCRIPTION OF THE DRAWINGS

FIGS. 1a and 1b illustrate an embodiment of the present invention.

FIG. 2 is an exploded view illustrating an embodiment of the present invention.

FIG. 3 is a partial cut-away plan view of an embodiment of the present invention.

FIG. 4 is a plan view illustrating the installation of an embodiment of the present invention.

### DETAILED DESCRIPTION OF THE INVENTION

The present invention will now be described in terms of the presently preferred embodiment thereof as illustrated in the appended drawings. This description should not be construed as limiting the scope of the appended claims.

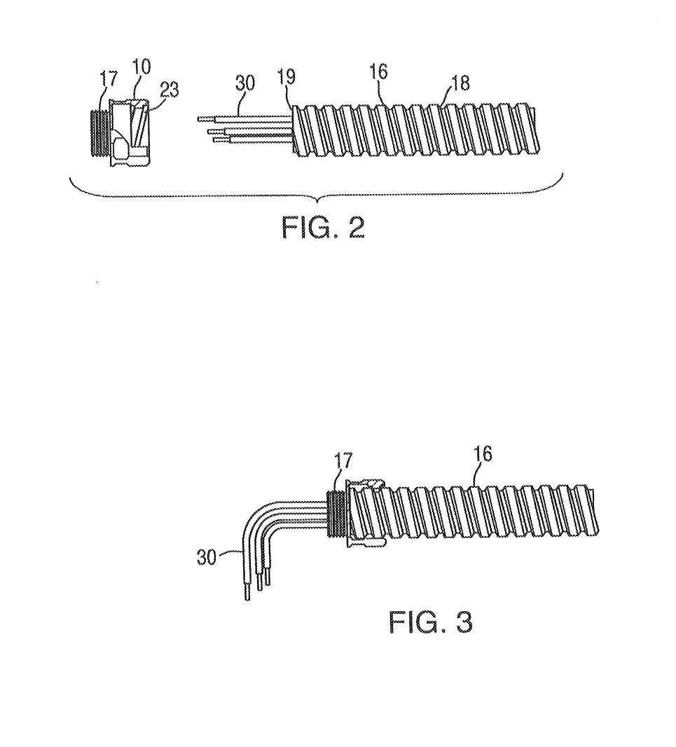

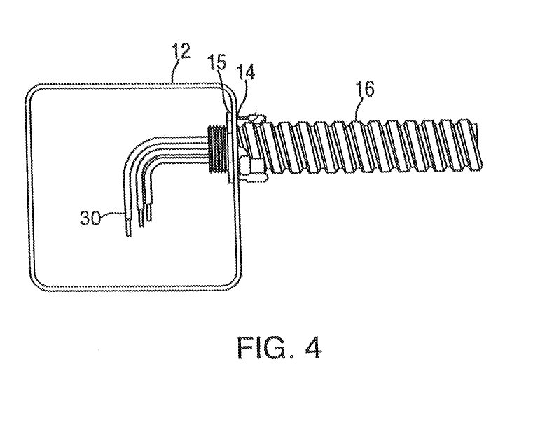

The twisted quick connector 10 of the present invention is illustrated in the figures. An electrical junction box 12 is illustrated in FIG. 4. The electrical junction box 12 has an opening 14 in its side through which an armored conduit or cable 16 is mounted. The armored cable or conduit 16 is generally fabricated from metal such as steel. The armored cables 16 are formed with an external spiral shape 18. As shown in FIG. 2, a plurality of electrical wires 30 are placed inside the armored cable 16 for connection inside the electrical junction box 12.

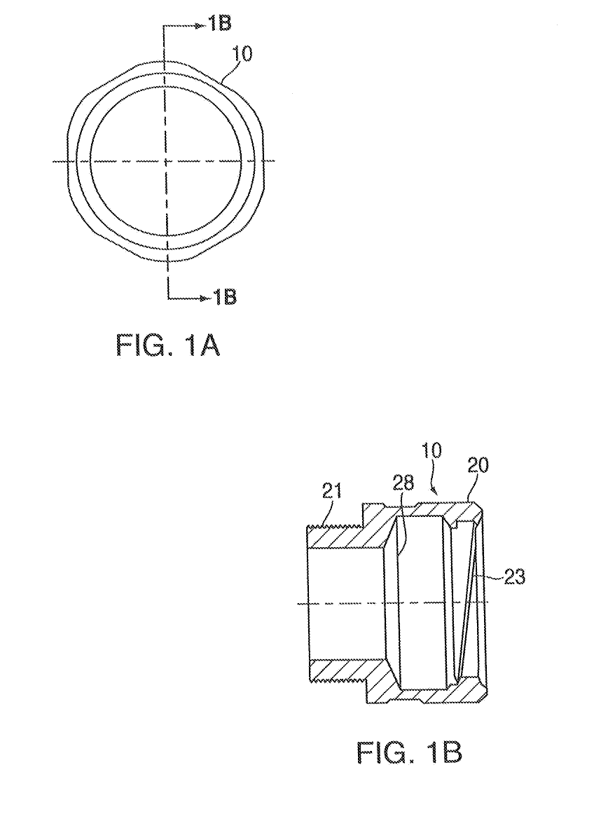

The twisted quick connector 10 is illustrated in FIGS. 1a and 1b. The twisted quick connector 10 comprises a first end 20 and a second end 21. The first end 20 comprises a hexagonal exterior surface and internal spiral worm threads 23. The external diameter of the second end 21 is adapted for easy insertion into the opening 14 in the electrical junction box 12. The twisted quick connector 10 comprises external threads 17 to be used for attaching it to the electrical junction box 12. The second end 21 is inserted through the external opening 14 and secured thereto with a locknut 15 threaded from inside the box onto the external threads 17 of the connector 10, as shown in FIG. 4.

The twisted quick connector 10 is fabricated of conductive metal such as steel and/or aluminum and is protected by conductive plating on top of the metal. The plating allows the twisted quick connector 10 to be corrosion protected and conductive at the same time for the electrical grounding purposes. The twisted quick connector 10 can be fabricated in a variety of sizes, from ⅜″ up to 4″, and is proportionally changed with its size.

The internal spiral worm threads 23 on the first end 20 of the twisted quick connector 10 are adapted to engage the external spiral shape 18 on the armored cable 16. In practice, the twisted quick connector 10 is thus mounted to the armored cable 16 by rotating the internal worm threads 23 onto the external spiral shape 18. The armored cable is then mounted to the electrical junction box 12 by inserting the second end 21 into the opening 14 and tightening the connector 10 into the locknut 15. The hexagonal outer surface allows for easier installation with hand tools such as an open wrench.

Further, since the twisted quick connector 10 screws onto the external spirals 18 of the armored cable 16, the leading edge 19 of the armored cable 16 is in contact with the internal stop 28 of the twisted quick connector 10. The leading edge 19 is generally sharp and can cut through the insulation on the wires 30 and create a possible short. Since the leading edge 19 contacts the internal stop on the twisted quick connector, the wires do not contact the leading edge and the danger of cutting the insulation is obviated without the use of plastic bushings as in currently available armored cable connectors.

Those of ordinary skill in the art will recognize that the foregoing merely represents one embodiment of the present invention. Many obvious modifications may be made thereto without departing from the spirit or scope of the present invention as set forth in the appended claims.

What is claimed is:

1. A connector for connecting an armored electrical conduit comprising a spiral exterior to an opening in an electrical junction box comprising:
a. a generally cylindrical body with a hollow tubular interior comprising a first end and a second end adapted to receive a plurality of electrical wires in the hollow tubular interior; and
b. wherein the first end comprises a connector to engage the exterior threads of the armored electrical conduit and the second end is adapted to be connected to the opening in the electrical junction box by engaging a fastener.

2. The connector of claim 1 wherein the first end further comprises a generally hexagonal exterior with a first set of spiral worm threads on its interior surface and an internal stop whereby the first set of threads are adapted to engage the spiral exterior of the armored electrical conduit whereby the connector is rotated over the spiral exterior of the armored cable until the stop contacts a leading edge of the armored electrical conduit.

3. The connector of claim 2 wherein the second end further comprises an external diameter adapted to be received in the opening in the electrical junction box, and a second set of threads on an exterior surface of the second end adapted to be received in a locknut to secure the connector and the armored conduit to the electrical junction box.
